(19) United States
(12) Patent Application Publication
(10) Pub. No.: US 2006/0023812 A1
(43) Pub. Date: Feb. 2, 2006

(54) Providing correction for carrier frequency offset in multi-carrier communication systems

(75) Inventor: Ganesan THIAGARAJAN, Bangalore (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/160,708

(22) Filed: Jul. 6, 2005

Related U.S. Application Data
(60) Provisional application No. 60/592,302, filed on Jul. 28, 2004.

(51) Int. Cl. H04L 27/22; H04L 27/16

(52) U.S. Cl. 375/326

(57) ABSTRACT

A receiver device provided according to an aspect of present invention accurately recovers streams of symbols encoded in corresponding sub-channels of a multi-carrier signal. Such a feature is attained by first recovering erroneous symbols (which are not yet corrected for carrier frequency offset) from the sub-channels, and then processing the symbols to correct for carrier frequency offset in the frequency domain. In one embodiment, the processing operation is performed by multiplying the symbols by an inverse of a G matrix

### RELATED APPLICATION

The present invention claims priority from co-pending U.S. provisional application Ser. No 60/592,302, Entitled, “Frequency domain correction of residual offset correction in OFDM and DMT systems”, Filed on Jul. 28, 2004, naming Ganesan THIAGARAJAN as inventor, and is incorporated in its entirety herewith.

### BACKGROUND OF THE INVENTION

1. Field of the Invention

The present invention relates telecommunication systems and more specifically to a method and apparatus providing correction for carrier frequency offset in multi-carrier communication systems.

2. Related Art

Multi-carrier communication (MC) techniques are often used both in wire-line and wireless telecommunication systems to transmit multiple streams of symbols, with each symbol typically containing one or more bits. In a sender device of a MC system, a transmission band is divided into a number of narrow bandwidth sub-channels. Each stream of symbols is represented using a corresponding sub-channel carrier signal having a frequency within the sub-channel bandwidth as described briefly below.

Generally each sub-channel carrier signal is modulated (using techniques such as Quadrature Phase Shift Keying (QPSK), Quadrature Amplitude Modulation (QAM) and multilevel shift keying (MSK), well known in the relevant arts) to encode the corresponding stream of symbols. The resulting modulated sub-channel carrier signals are added together to generate a single base-band multi-carrier signal (typically using transforms such as inverse discrete Fourier transform (IDFT) or inverse fast Fourier transform (IFFT), also well known in the relevant arts). The entire base-band multi-carrier signal is then modulated to shift to a desired higher frequency band suitable for transmission using a high frequency carrier signal.

A receiver device obtains the base-band multi-carrier signal by shifting the higher frequency band signal back to the base-band frequency (commonly referred to as “down conversion”). The stream of symbols encoded in each sub-channel is then derived from the base-band signal by using transform techniques (in conjunction with transmitter system) such as DFT, FFT, etc., also well known in the relevant arts. The data corresponding to each symbol is then recovered by suitably demodulating (based on the modulation technique adapted at the transmitter system) the corresponding sub-channel carrier signal (using QPSK/QAM/MSK demodulator).

Typically, at the receiver device, the down conversion (shifting of high frequency signal to base band signal) is performed using a locally generated carrier signal having a frequency value equal to the high frequency carrier signal used at the sender device. The difference in frequency value of locally generated carrier signal and carrier of the received signal is generally referred to as a carrier frequency offset.

One requirement for accurate recovery of data using MC techniques is that the frequency of the locally generated carrier signal used in the receiver device, needs to equal the frequency of the signal transmitted. In other words, the carrier frequency offset needs to ideally equal zero.

Several challenges may be posed in meeting such a requirement. For example, given that sender and receiver devices operate at large distances asynchronously, it may be difficult to precisely determine the carrier frequencies used in the sender devices. In addition, the carrier frequencies may drift in the transmission channel from the sender device to the receiver device due to various effects such as Doppler Effect, as is well known in the relevant arts.

Due to such carrier frequency offset, data bits from a multi-carrier system may not be recovered accurately. Such a problem is of particular concern in telecommunication systems using Orthogonal Frequency Division Multiplexing (OFDM) techniques or Discrete Multi-tone Techniques (DMT) due to the overlap of the sub-channel frequencies.

Hence what is needed is an efficient method and apparatus providing correction for carrier frequency offset in multi-carrier communication systems.

### BRIEF DESCRIPTION OF THE DRAWINGS

Various features of the present invention are described with reference to the following accompanying drawings, which are briefly described below.

Figure (FIG.) 1 is a block diagram illustrating an example multi-carrier telecommunication system in which several aspects of the present invention can be implemented.

FIG. 2 is a graph illustrating the effect of carrier frequency offset on multi-carrier signals in a typical scenario.

FIG. 3A is block diagram illustrating the details of an example OFDM de-modulator in a prior embodiment.

FIG. 3B is a block diagram illustrating the implementation of frequency correction block in one prior embodiment.

FIG. 4 is a flowchart illustrating an approach to provide correction for carrier frequency offset in multi-carrier communication systems according to an aspect of the present invention.

FIG. 5 is a block diagram illustrating the details of an example OFDM multi-carrier receiver providing correction to carrier frequency offset according to an aspect of present invention.

FIG. 6 is a flowchart illustrating the manner in which a multiplication operation needed to correct carrier frequency offset is performed according to an aspect of the present invention.

In the drawings, like reference numbers generally indicate identical, functionally similar, and/or structurally similar elements. The drawing in which an element first appears is indicated by the leftmost digit (s) in the corresponding reference number.

### DETAILED DESCRIPTION

### 1. Overview

A receiver device provided according to an aspect of present invention accurately recovers streams of symbols encoded in corresponding sub-channels of a multi-carrier signal. Such a features is attained by first recovering erroneous symbols (which are not yet corrected for carrier frequency offset) from the sub-channels, and then processing the symbols to correct for carrier frequency offset.

In one embodiment, the processing operation is performed by multiplying the symbols by an inverse of a G matrix described below in further detail. Another aspect of the present invention provides an approach to perform such multiplication.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### 2. Example Multi-Carrier Telecommunication System

FIG. 1 is a block diagram illustrating an example multi-carrier telecommunication system in which several aspects of the present invention can be implemented. The block diagram is shown containing transmitter device 110, receiver device 160, interface block 180 and microprocessor 190. Each block is described below in further detail.

Transmitter device 110 is further shown containing Orthogonal Frequency Division Multiplexing (OFDM) modulator 120, up-converter 130, power amplifier 140 and transmitter antenna 149. OFDM modulator 120 receives a number of bit streams 101-103 and generates a multi-carrier signal (base band) on path 123. Up-converter 130 receives the multi-carrier signal on path 123 and shifts the multi-carrier signal to higher frequency band using a high frequency (f1c) carrier signal 134. Power amplifier 140 amplifies a high frequency signal (RF signal) and transmits using antenna 149.

Receiver device 160 is shown containing RF front end 165, down-converter 170 and OFDM demodulator 175. RF receiver 165 receives a high frequency signal (RF signal) through antenna 161 and performs various amplification and filtering operations to eliminate unwanted frequencies. The filtered high frequency signals are provided to down-converter 170. The down converter uses a locally generated high frequency (f2c) signal 173 to produce a base-band multi-carrier signal.

OFDM demodulator 175 demodulates the multi-carrier signal to generate bits stream corresponding to each sub-channel. OFDM de-modulator 175 may be implemented in digital domain by sampling the multi-carrier signal with a desired sampling rate. Interface block 180 receives the bits stream from OFDM demodulator and provides the bit stream to microprocessor 190 with suitable voltage level. Microprocessor 190 may perform various operations on the received bit stream potentially to provide various user applications (e.g., web browsing, voice call, teleconferencing, etc.)

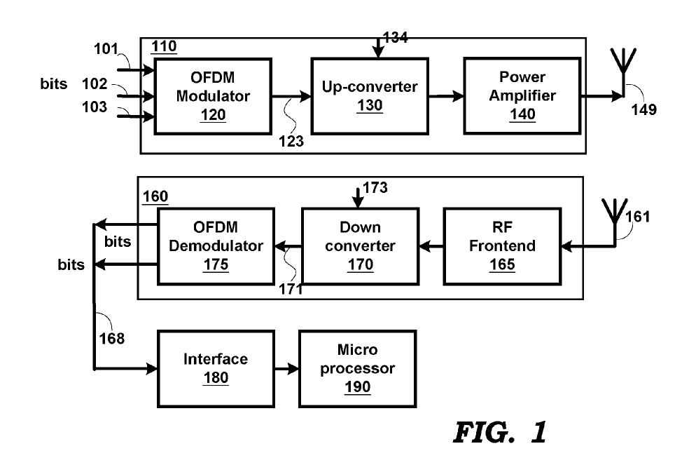

OFDM demodulator 175 provided according to various aspects of the present invention corrects for any carrier frequency offsets in the multi-carrier signal received from down converter 170. The operation and implementation of OFDM demodulator can be appreciated with a clear understanding of the effect of carrier frequency offset, and accordingly carrier frequency offset is illustrated below with respect to FIG. 2.

### 3. Carrier Frequency Offset

FIG. 2 is a graph (with frequency on X-axis and signal strength on Y-axis) illustrating the effect of carrier frequency offset on multi-carrier signal in a typical scenario. The graph is shown containing signals 230 and 270. Signal 230 represents a multi-carrier signal 123 generated by OFDM modulator 120 and signal 270 represents a multi-carrier signal received by OFDM demodulator 175 from down convertor 170.

Curves 211-215 represents the narrowband sub-channels of a multi-carrier signal in a frequency domain. Frequency points 231-235 represent carrier frequencies of the corresponding sub-channels. In an OFDM system, carrier frequencies of sub-channels 231-235 are selected to be orthogonal (as well known in the relevant art) to each other.

Due to such a feature, the frequency bands of sub-channels overlap. For example, sub-channels 211 is shown overlapping with sub channel 212 such that the signal level of sub-channel 211 is zero at carrier frequency (center frequency) of sub-channel 212. Due to such overlapping, it is ideally desirable to measure signal levels (to extract symbols) of each sub-channel with respect to corresponding carrier frequency. Otherwise, the interference caused by the adjacent sub-channels may introduce errors in the recovered symbols (data).

Signal 270 represents multi-carrier signal received after down conversion is performed by down converter 170. The signal is shown containing sub-channels 211-215 with corresponding center frequency (sub-channel carrier frequency) 271-275. The sub-channel carrier frequencies 271-275 potentially may respectively be different from the carrier frequencies 231-235, and the corresponding carrier frequency offset is represented by offset/drift 290.

As noted above, one reason for such difference is the difference in locally generated frequency f2c used by down converter 170 with respect to frequency f1c used by up converter in transmitter device. Another reason may be due to Doppler shift (effect) caused due to the relative movement between the transmitter and receiver.

Drift 290 may cause an error in the symbols extracted by OFDM demodulator 175 unless corrective action is taken. The magnitude of error caused generally depends upon drift 290. Approaches provided according to various aspects of the present invention provide correction after estimating drift 290.

Various aspects of the present invention will be clearer in comparison to a prior system in which at least some features of the present invention are not implemented. Accordingly, the details of such a prior system are described below first.

### 4. Prior Carrier Frequency Offset Correction Technique

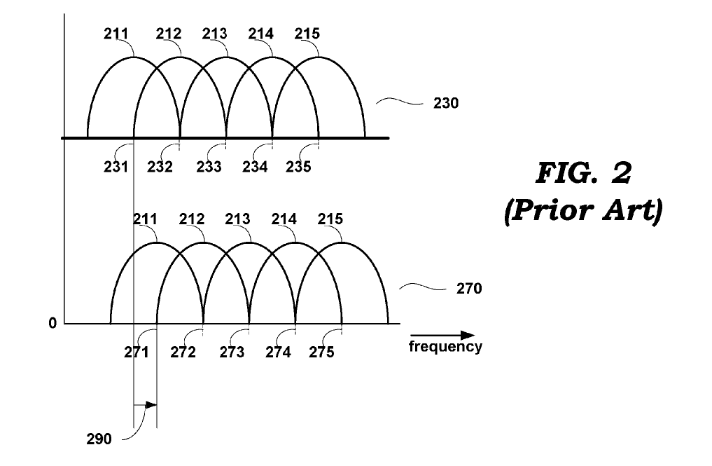

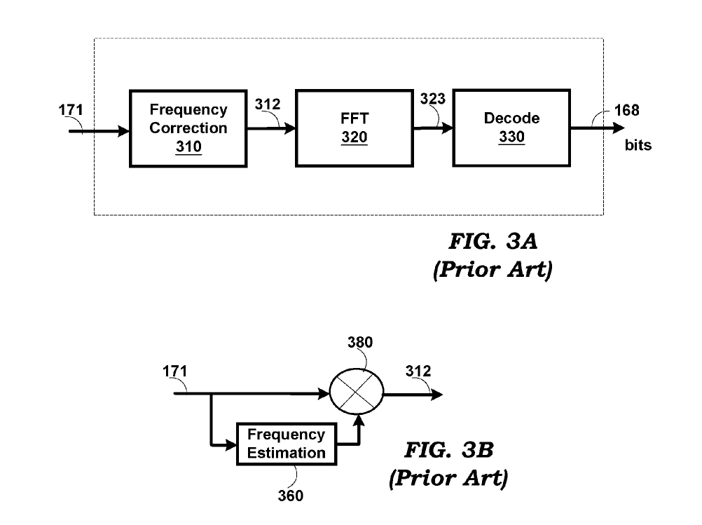

FIG. 3A is block diagram illustrating the details of an example OFDM de-modulator (which can be used in the place of 175 of FIG. 1) in a prior embodiment. The block diagram is shown containing frequency correction block 310, Fast Fourier Transform (FFT) 320, and decoder 330. Each block is described below in further detail.

FFT 320 receives a multi-carrier base band signal from correction block 310 on path 312 and recovers symbols corresponding to each sub-channel by using transform techniques such as DFT or FFT as noted above. Decoder 330 converts each symbol into corresponding data bits and provides stream of data on path 168.

Frequency correction block 310 receives signal 270 from down converter 170 on path 171. Frequency correction block 310 provides a correction for frequency drift 290 and provides corrected multi-carrier signal on path 312. Hence, multi-carrier signal 270 having center frequency 271-275 is shifted towards the value 231-235, there by reducing frequency offset 290. The manner in which frequency correction block 310 is implemented in one prior embodiment is described below with respect to FIG. 3B.

FIG. 3B is a block diagram illustrating the implementation of frequency correction block 310 in one prior embodiment. The block diagram is shown containing frequency estimation 360 and multiplier 380. Each block is described below in further detail.

Frequency estimation block 360 generates a phaser signal (e^{jθt}), wherein phaser value (θ) is proportionate to estimated frequency drift. Estimation of the frequency drift can be performed using techniques well known in the field of art. In one embodiment, frequency estimation block 360 is trained to observe the received multi-carrier signal and the decoded symbols/bits over a period of time, and to adaptively adjust the phaser value. The generated phaser signal is provided to multiplier 380.

Multiplier 380 multiplies the received multi-carrier signal (270) with phaser signal received from drift estimation block. When OFDM demodulator is implemented in digital domain, multiplication operation is performed for each sample of the multi-carrier signal. Due to such multiplication each frequency component in the multi-carrier signal gets shifted by the magnitude of the phaser value (θ), thereby providing (reducing drift 290) correction for the carrier frequency drift.

One disadvantage with such an approach is that unacceptably large number of computations may be required in situations requiring higher sampling rate (i.e., more samples per unit time, for example to attain high reliability of decoding). Such large number of computations may be required because each sample is multiplied by the phaser signal, as noted above.

Another disadvantage with such system is estimated frequency drift may not be accurate due to the delay in estimation of the correction. Such delay is caused since the information required to estimate frequency drift is available only after symbols are extracted from the multi-carrier signal (typically after FFT 320). Various aspect of present invention overcome at least some of the disadvantages described above.

### 5. Correction for Carrier Frequency Offset

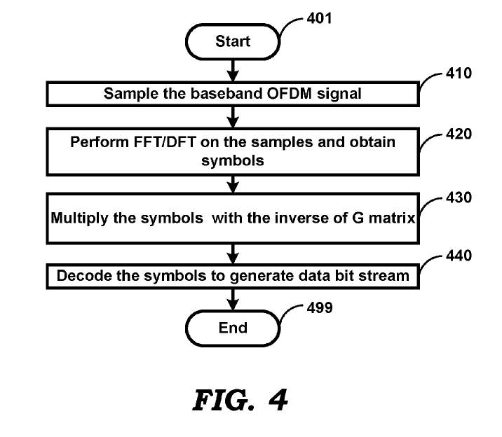

FIG. 4 is a flowchart illustrating an approach to provide correction for carrier frequency offset in multi-carrier communication systems according to an aspect of the present invention. The flow chart is described with respect to OFDM demodulator 175 for illustration. However, the features can be implemented in other environments as well. The flowchart begins in step 401 and control passes to step 410.

In step 410, OFDM demodulator 175 samples the base band OFDM signal received from down converter 170. In step 420, OFDM demodulator 175 perform FFT/DFT on the samples to obtain symbols. According to one approach, FFT is used if the number of samples to be processed is large (e.g., of the order of 2 power n, where n is an integer), and DFT is used otherwise. Typically transformation is performed over a set of sample values resulting in a set of symbols corresponding to each sub-channel. The resulting symbols may contain error due to frequency offset (drift) requiring correction.

In step 430, OFDM demodulator 175 multiplies the symbols (Result) with the inverse of a G matrix (G⁻¹) to correct the drift. A set of N sequential symbols (symbol vector representing a (1×N) matrix) are multiplied with the inverse matrix G to obtain set of corrected symbols ( corrected symbol vector) wherein G matrix (N×N) is given by:

$${G}_{l , k} = {ⅇ}^{- jπ \frac{l - k + {δ}_{f}}{MN}} [ \frac{sin ( \frac{π ( l - k + {δ}_{f} )}{M} )}{sin ( \frac{π ( l - k + {δ}_{f} )}{MN} )} ] \qquad Equation ( 1 )$$

wherein G_{1,k} represents an element on 1^{th} row and k^{th} column in G matrix, δ_{f} represents the estimated carrier frequency offset divided by f1 (sub-channel carrier frequency), and M and N are integers representing factors determining the sampling rate. Each term is described in following sections in detail.

It may be appreciated that the correction of the symbols is performed in frequency domain (since FFT precedes the correction of step 430), while the prior approach of FIG. 3A performs the correction in time domain (performing correction on the multi-carrier base-band signal before FFT).

In step 440, OFDM demodulator decodes the symbols. The corrected set of symbols are used to obtain corresponding data bits. The flow chart ends in step 499. The correction noted above is based on the premise that multiplication of the symbols by G⁻¹ provides the desired correction to the carrier frequency offset. The basis for such an assertion is illustrated below.

### 6. Basis/Proof

The multi-carrier base band signal (at the transmitter device) having N sub-channels and with separation of corresponding center frequencies (carrier frequency) being f1, may be represented as:

$$s ( t ) = {\sum }_{k = - N / 2}^{N / 2 - 1} {s}_{k} {ⅇ}^{j2π {kf}_{1} t} , 0 \leq t < 1 / f1 , … \qquad Equation ( 2 )$$

wherein sₖ represents a symbol value from the corresponding sub-channel, t represents the time point at which the sample has been taken, f₁ is the center frequency of the sub-channel as noted above, j and π representing standard notations used in complex exponential representation as is well known in the relevant arts, and k taking values from −N/2 to ((N/2)−1), a total of N values.

The signal s(t) is up-converted by up converter 130 using a high frequency carrier signal f_{c}. The resulting up converted signal R{ } may be represented as: [symbol]
{s(t)e^{j2πfct}}={s(t)}cos 2πfct−{s(t)}sin 2πfct Equation(3)

wherein R and I represents a real and imaginary part, s(t) is defined in Equation (2) above, and the high frequency signal R{s(t)e^{j2πfct}} is transmitted by transmitter 110.

The receiver device 160 receives the transmitted signal R{s(t)e^{j2πfct}} through RF receiver 165 and provides the received signal to down-converter 170. Down-converter 170 performs down conversion using locally generated carrier signal having offset (f_{Δ} 290). The resulting down converted base-band signal may be represented as:

$$r ( t ) = {\sum }_{k = - N / 2}^{N / 2 - 1} {s}_{k} {ⅇ}^{j2π {kf}_{1 t}} {ⅇ}^{j2π {f}_{Δ t}} , 0 \leq t < 1 / f1 , … \qquad Equation ( 4 )$$

The received signal r(t) is sampled at a rate MNf₁, wherein M represents a over sampling factor and N is defined above with respect to Equation (2). The sampling may be performed at down-converter 170 or at OFDM demodulator 175. The sampled values of the received signal r(t) may be represented as:

$$r ( n ) = {\sum }_{n = - MN / 2}^{MN / 2 - 1} {s}_{k} {ⅇ}^{j2π} [ \frac{kn}{MN} + \frac{{f}_{Δ} n}{{MNf}_{1}} ] \qquad Equation ( 4 A )$$

The samples of the received base band signal are provided to OFDM demodulator 175 as noted in step 410 above. A N-point DFT or FFT(transformation) is performed (as noted above in step 420) on set (MN) of samples received to obtain symbols corresponding to a sub-channel. The recovered symbols may be represented as:

$${\hat{s}}_{k} = {\sum }_{l = - N / 2}^{N / 2 - 1} {s}_{l} {\sum }_{n = - MN / 2}^{MN / 2 - 1} {ⅇ}^{j2π} [ \frac{( l - k ) n}{MN} + \frac{{f}_{Δ} n}{{MNf}_{1}} ] \qquad Equation ( 5 )$$

Using Equation (1), Equation (5) may be rewritten as:
Ŝ=Gs Equation(6)

wherein s represents the set of recovered symbols for all values of k and Ŝ represents the transmitted symbol values as in Equation (1).

Accordingly, from Equation (6), it can be appreciated that the transmitted symbols can be correctly obtained by multiplying the received symbols with inverse of Matrix G, as noted above with respect to step 430.

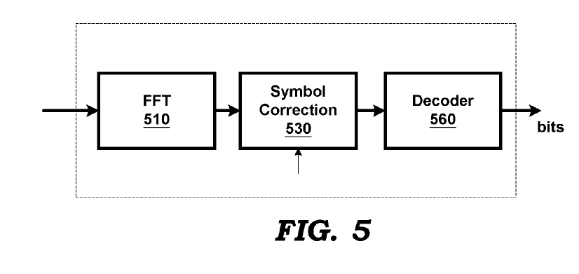

The principle of above can be used and implemented in several embodiments and environments, as will be apparent to one skilled in the relevant arts by reading the disclosure provided herein. An example embodiment implementing the principle is described below in FIG. 5.

### 7. Example Embodiment

FIG. 5 is a block diagram illustrating example an OFDM multi-carrier receiver providing correction to carrier frequency offset according to an aspect of present invention. The block diagram is shown containing FFT 510, symbol correction 530 and decoder 560. Each block is described bellow in further detail.

FFT 510 receives samples of multi-carrier signal (base band) from down converter 170 with a carrier frequency drift (offset). FFT 510 recovers the symbols (containing error) from the received samples of multi-carrier signal by using various transform techniques (DFT, FFT etc,) as noted above. Due to the frequency offset in the received multi-carrier signal, the values of the symbols would be erroneous. The erroneous symbols are then provided to the symbol correction block 530.

Symbol correction block 530 provides correction by multiplying received symbols with inverse G matrix according to step 430. The corrected symbols may be provided to decoder 560, which recovers the data bits from each symbol. The resulting data stream may be provided to interface 180.

Symbol correction block 530 may generate G matrix from Equation (1) by using an estimated frequency offset (Δ_{f}/f₁), which can be determined in a known way. In an embodiment, the preambles (bits providing information corresponding to carrier frequency of the received signal) contained in symbols are used to determine frequency offset. Symbol correction block 530 determines the G-matrix (based on the estimation), performs an inversion of G and multiplies the received symbols with G⁻¹.

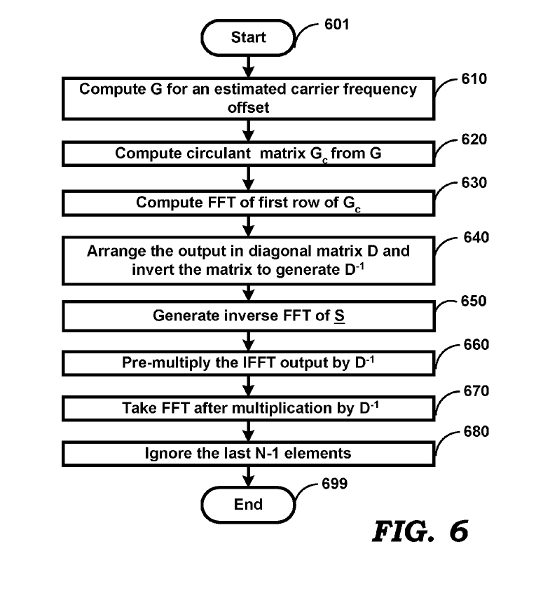

The inversion and multiplication operations can be simplified by using various properties exhibited by matrix G such as diagonally dominant, full rank, Toeplitz matrix (for values of land k greater than 1 G_{1,k}=G_{1-1,k-1}) and circulant matrix (For M equal to 1 and 1 greater than 1, G_{1,1}=G_{1-1,N}). An example approach for such operation is described below with reference to FIG. 6.

### 8. Determining G⁻¹ and Multiplying

FIG. 6 is a flowchart illustrating the manner in which G⁻¹ may be determined and multiplied with symbols according to an aspect of the present invention. The flowchart is described in relation to implementation of correction block 530. However, the approaches can be implemented in other environments as well. Also, the approaches can be implemented as a combination of one or more of hardware, software and firmware, depending on the specific design requirements. The flow chart begins in step 601 and control passes to step 610.

In step 610, correction block 530 computes G for an estimated frequency offset. The frequency offset may be estimated as described above and matrix G can be generated using equation 1.

In step 620, correction block 530 computes circulant matrix G_{c} (defined above) from matrix G. The manner in which G_{c} can be generated is described in the following section. However, it is helpful to note that G_{c} would be a square matrix of dimension (2N−1).

In step 630, correction block 530 computes FFT of the first row of G_{c}. FFT is performed with 2N−1 points.

In step 640, correction block 530 arranges the output ((2N−1) elements) in a diagonal matrix D and inverts the matrix to generate D⁻¹. The inversion can be performed using techniques well known in the relevant arts. In step 650, correction block 530 generates inverse FFT of ŝ, wherein ŝ is generated by stacking (N−1) zeros to the N erroneous symbols (sought to be corrected).

In step 660, correction block 530 multiplies the result of IFFT in step 650 with D⁻¹, also generated above. In step 670, correction block 530 performs FFT of the result (2N−1 points) of step 660. In step 680, correction block 530 ignores the last N−1 elements and provides N symbols as output to decoder 560. The flowchart ends in step 699.

The approach of FIG. 6 is based on the premise that the steps together perform multiplication by G⁻¹. The basis for such an assertion is illustrated below with an example.

### 9. Proof of Multiplication by G⁻¹

Various steps in FIG. 6 are illustrated assuming the G matrix is given by Equation (7) below:

$$G = [ \begin{matrix}{t}_{0} & {t}_{1} & … & {t}_{n} \\ {t}_{- 1} & {t}_{0} & … & {t}_{n - 1} \\ ⋮ & ⋮ & ⋰ & ⋮ \\ {t}_{- n} & {t}_{- n + 1} & … & {t}_{0}\end{matrix} ] \qquad Equation ( 7 )$$

The corresponding circulant matrix G_{c} according to step 620 is obtained by constructing an extended circulant matrix from the elements of G matrix as illustrated below with respect to Equation (8):

$$Gc = [ \begin{matrix}{t}_{0} & {t}_{1} & … & {t}_{n} & {t}_{- n} & {t}_{- n + 1} & … & {t}_{- 1} \\ {t}_{- 1} & {t}_{0} & … & {t}_{n - 1} & {t}_{n} & {t}_{- n} & … & {t}_{- 2} \\ ⋮ & ⋮ & ⋰ & ⋮ & ⋮ & ⋮ & ⋰ & ⋮ \\ {t}_{- n} & {t}_{- n + 1} & … & {t}_{0} & {t}_{1} & {t}_{2} & … & {t}_{n} \\ {t}_{n} & {t}_{- n} & … & {t}_{- 1} & {t}_{0} & {t}_{1} & … & {t}_{n -} 1 \\ ⋮ & ⋮ & ⋰ & ⋮ & ⋮ & ⋮ & ⋰ & ⋮ \\ {t}_{1} & {t}_{2} & ⋮ & {t}_{- n} & {t}_{- n + 1} & {t}_{- n + 2} & … & {t}_{0}\end{matrix} ] \qquad Equation ( 8 )$$

The circulant matrix G_{c} is of the order 2N−1. Hence the corresponding vector s (symbols) is extended by stacking N−1 zeros at the bottom. Hence Equation (6) may be represented with the circulant matrix as:
Ŝ=Gc[S^{T}|01×N−1]^{T} Equation(9)

wherein S^{T} represents the transpose of vector S and | represents a matrix adjoining/merge operation. Equation (9) may be represented as
Ŝ=G_{c}s⁺ Equation(10)
wherein
S⁺=[S^{T}|01×N−1]^{T} Equation(11)
As a result, from equation 10 the correct symbols may be obtained from the received symbols as
S⁺=Gc⁻¹Ŝ⁺ Equation(12)
Calculation of G_{c}⁻¹ is simplified using properties of matrix G_{c} and the simplifed equation is given as:
S⁺=FΛ⁻¹F^{H}Ŝ⁺ Equation(13)

wherein F represents FFT, F^{H} represents a inverse FFT. The above equation is implemented in steps 630 through 670.

It should be appreciated that various modifications can be made to the above-described embodiments without departing from the scope and spirit of various aspects of the present invention. For example, Levinson-Durbin recursive approaches for solving the G-matrix can be used instead of the above-described example approaches.

Similarly, matrix G of Equation (1) corresponds to a scenario in which IFFT is computed for sub-carriers −(N/2) to +(N/2)−1 (total of N sub-channels). However, G can be computed for other sub-carrier ranges without departing from the scope and spirit of various aspects of the present invention. For example, the sub-carrier range can equal 0 to (N−1) and a corresponding matrix G can be attained and used.

Thus using the approaches described above, carrier frequency offset can be corrected. The approach of above may provide several advantages. For example, since the correction is provided after extraction of symbols, symbol correction block 530 is independent of the sampling rate (number of samples) at which multi-carrier signal is sampled. Further the offset information contained in the symbols (e.g., as preambles and pilot symbols) may readily be used for estimating the frequency offset, and applied to symbols immediately.

### 10. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method of accurately recovering a plurality of streams of symbols from a multi-carrier signal in a receiver system, each of said plurality of stream of symbols being encoded in a corresponding one of said plurality of sub-channels in said multi-carrier signal, said method comprising:
receiving said multi-carrier signal with a first carrier frequency;
down-converting said multi-carrier signal using a second carrier frequency to generate a base-band multi-carrier signal, wherein a carrier frequency offset equals a difference of said first carrier frequency and said second carrier frequency;
sampling said base-band multi-carrier signal to generate a first plurality of samples;
performing a transform on said first plurality of samples to obtain a corresponding first plurality of symbols; and
processing said first plurality of symbols to correct for said carrier frequency offset.

2. The method of claim 1, wherein each of said first plurality of symbols corresponds to a corresponding one of said plurality of sub-channels.

3. The method of claim 2, wherein said processing comprises multiplying said first plurality of symbols with a matrix.

4. The method of claim 3, wherein said matrix exhibits characteristics of a Toeplitz matrix.

5. The method of claim 3, wherein said matrix exhibits circulant characteristic.

6. The method of claim 3, wherein said matrix equals an inverse of a G matrix, wherein said G matrix equals:
$${G}_{l , k} = {ⅇ}^{- jπ \frac{l - k + {δ}_{f}}{MN}} [ \frac{sin ( \frac{π ( l - k + {δ}_{f} )}{M} )}{sin ( \frac{π ( l - k + {δ}_{f} )}{MN} )} ]$$
wherein G_{1,k} represents an element on 1^{th} row and k^{th} column in said G matrix, δ_{f} represents a fraction of estimated fractional carrier frequency offset, N represents a number of samples, and M represents a over-sampling factor.

7. The method of claim 6, wherein said processing comprises:
computing a circulant matrix G_{c} from G, wherein G and G_{c} respective have dimensions of (N) and (2N−1);
computing a Fourier Transform of a first row of G_{c} to generate an output;
arranging said output in diagonal matrix D;
inverting said diagonal matrix to generate D⁻¹;
generating a vector by padding zeros to said first plurality of symbols;
generate an inverse Fourier Transform of said vector;
pre-multiplying a result of said inverse Fourier Transform by D⁻¹; and
perform a Fourier transform of a result of said pre-multiplying and using a first (N) elements of the result as a plurality of corrected symbols of corresponding sub-channels.

8. The method of claim 3, wherein said transform comprises Fourier Transforms.

9. The method of claim 3, wherein said multi-carrier signal is generated using a source carrier frequency in a sender system, wherein said source carrier frequency is not equal to said first carrier frequency.

10. An apparatus in a receiver device for accurately recovering a plurality of streams of symbols from a multi-carrier signal in a receiver system, each of said plurality of stream of symbols being encoded in a corresponding one of said plurality of sub-channels in said multi-carrier signal, said apparatus comprising:
a receiver receiving said multi-carrier signal with a first carrier frequency;
a down-converter down-converting said multi-carrier signal using a second carrier frequency to generate a base-band multi-carrier signal, wherein a carrier frequency offset equals a difference of said first carrier frequency and said second carrier frequency;
a demodulator sampling said base-band multi-carrier signal to generate a first plurality of samples, said demodulator performing a transform on said first plurality of samples to obtain a corresponding first plurality of symbols, and processing said first plurality of symbols to correct for said carrier frequency offset.

11. The apparatus of claim 10, wherein each of said first plurality of symbols corresponds to a corresponding one of said plurality of sub-channels.

12. The apparatus of claim 11, wherein said demodulator multiplies said first plurality of symbols with a matrix to perform said processing.

13. The apparatus of claim 12, wherein said matrix exhibits characteristics of a Toeplitz matrix.

14. The apparatus of claim 12, wherein said matrix exhibits circulant characteristic.

15. The apparatus of claim 12, wherein said matrix equals an inverse of a G matrix, wherein said G matrix equals:
$${G}_{l , k} = {ⅇ}^{- jπ \frac{l - k + {δ}_{f}}{MN}} [ \frac{sin ( \frac{π ( l - k + {δ}_{f} )}{M} )}{sin ( \frac{π ( l - k + {δ}_{f} )}{MN} )} ]$$
wherein G_{1,k} represents an element on 1^{th} row and k^{th} column in said G matrix, δ_{f} represents a fraction of estimated fractional carrier frequency offset, N represents a number of samples, and M represents a over-sampling factor.

16. The apparatus of claim 15, wherein said demodulator is operable to:
compute a circulant matrix G_{c} from G, wherein G and G_{c} respective have dimensions of (N) and (2N−1);
compute a Fourier Transform of a first row of Gc to generate an output;
arrange said output in diagonal matrix D;
invert said diagonal matrix to generate D⁻¹;
generate a vector by padding zeros to said first plurality of symbols;
generate an inverse Fourier Transform of said vector;
pre-multiply a result of said inverse Fourier Transform by D⁻¹; and
perform a Fourier transform of a result of said pre-multiplying and use a first (N) elements of the result as a plurality of corrected symbols.

17. The apparatus of claim 12, wherein said transform comprises Fourier Transforms.

18. The apparatus of claim 12, wherein said multi-carrier signal is generated using a source carrier frequency in a sender system, wherein said source carrier frequency is not equal to said first carrier frequency.

19. A receiver device for accurately recovering a plurality of streams of symbols from a multi-carrier signal in a receiver system, each of said plurality of stream of symbols being encoded in a corresponding one of said plurality of sub-channels in said multi-carrier signal, said apparatus comprising:
means for receiving said multi-carrier signal with a first carrier frequency;
means for down-converting said multi-carrier signal using a second carrier frequency to generate a base-band multi-carrier signal, wherein a carrier frequency offset equals a difference of said first carrier frequency and said second carrier frequency;
means for sampling said base-band multi-carrier signal to generate a first plurality of samples;
means for performing a transform on said first plurality of samples to obtain a corresponding first plurality of symbols; and
means for processing said first plurality of symbols to correct for said carrier frequency offset.

20. The system of claim 19, wherein said means for multiplying multiplies said plurality of samples with an inverse of a G matrix, wherein said G matrix equals:
$${G}_{l , k} = {ⅇ}^{- jπ \frac{l - k + {δ}_{f}}{MN}} [ \frac{sin ( \frac{π ( l - k + {δ}_{f} )}{M} )}{sin ( \frac{π ( l - k + {δ}_{f} )}{MN} )} ]$$
wherein G_{1,k} represents an element on 1ₜₕ row and kₜₕ column in said G matrix, δ_{f} represents a fraction of estimated fractional carrier frequency offset, N represents a number of samples, and M represents a over-sampling factor.

21. A method of performing frequency offset correction of a received signal in the frequency domain, said method comprising: computing G matrix and then performing a computation using the G⁻¹ matrix or using an approximation of G⁻¹, wherein G matrix equals:
$${G}_{l , k} = {ⅇ}^{- j π \frac{l - k + {δ}_{f}}{MN}} [ \frac{sin ( \frac{π ( l - k + {δ}_{f} )}{M} )}{sin ( \frac{π ( l - k + {δ}_{f} )}{MN} )} ]$$
wherein G_{1,k} represents an element on 1ₜₕ row and kₜₕ column in said G matrix, δ_{f} represents a fraction of estimated fractional carrier frequency offset, N represents a number of samples, and M represents a over-sampling factor.

22. A method of performing frequency offset correction of a received signal in the frequency domain, said method comprising: performing I/Q gain, phase imbalance correction in frequency domain; and then performing a computation using the G⁻¹ matrix or using an approximation of G⁻¹, wherein G matrix equals:
$${G}_{l , k} = {ⅇ}^{- j π \frac{l - k + {δ}_{f}}{MN}} [ \frac{sin ( \frac{π ( l - k + {δ}_{f} )}{M} )}{sin ( \frac{π ( l - k + {δ}_{f} )}{MN} )} ]$$
wherein G_{1,k} represents an element on 1ₜₕ row and kth column in said G matrix, δ_{f} represents a fraction of estimated fractional carrier frequency offset, N represents a number of samples, and M represents a over-sampling factor.
